(19) United States
(12) Patent Application Publication
(10) Pub. No.: US 2026/0084144 A1
(43) Pub. Date: Mar. 26, 2026

(54) COUPLING DEVICE FOR PIPETTE TIPS

(71) Applicant: Ritter GmbH, Schwabmuenchen (DE)

(72) Inventors: Frank FINIS, Augsburg (DE); Rüdiger CREUZBURG, Weimar (DE)

(21) Appl. No.: 19/323,726

(22) Filed: Sep. 9, 2025

(30) Foreign Application Priority Data
Sep. 26, 2024 (DE) 10 2024 127 883.8

(51) Int. Cl. B01L 3/02

(52) U.S. Cl. CPC B01L 3/0275; B01L 2200/025; B01L 2200/0689

(57) ABSTRACT

A coupling device 1 has a coupling base body 2 having a distal end plate 20, a groove 21 for a sealing means 3, a cylindrical region 23 and a shaft region. A stop plate 4 can be arranged on the shaft region. The coupling base body 2 also has an aspiration and discharge opening 25 extending axially through the entire coupling base body for aspirating or discharging fluids from or to a coupled pipette tip. A group of three (3) retaining elements 51, 52, 53 is provided. Each of the retaining elements 51, 52, 53 is positively guided by an actuator sleeve 6.

### TECHNICAL FIELD

The application relates to pipette tip holders and coupling devices, respectively, for pipette tips, such as pipette tips shown in WO2024/170593A1.

### PRIOR ART

In the state of the art, a large number of pipette tip coupling devices are known, for example for use with pipetting robots.

Coupling devices are usually designed to grip pipette tips and/or to seal between the pipette tip and the coupling device. For this purpose, the coupling device may have a mandrel that engages with the interior of a pipette tip from the top. After engagement, part of the engagement section (holding section) of the mandrel expands so that the pipette tip is held sealingly on the mandrel if necessary. The expanding engagement section may rest against the inner wall or in a groove formed in the inner wall of the pipette tip.

To release the pipette tip from the mandrel, the retaining section of the mandrel is retracted to its initial position so that the mandrel may be pulled out of the interior of the pipette tip or the pipette tip may be stripped off the mandrel with virtually no friction. In the prior art WO2024/170593A1, the retaining section is retracted by means of elastic return elements, for example.

### OBJECT OF THE INVENTION

The object of the present invention is to provide a coupling device for pipette tips that ensures reliable expansion and retraction of a retaining section of an engagement section of the coupling device.

### SUMMARY OF THE INVENTION

The object is solved by a coupling device according to the claims and as described below.

A coupling device according to the invention comprises: a coupling base body; at least one holding element that is radially movable relative to the coupling base body; at least one actuator element that is axially movable relative to the coupling base body; and a positive guide between the holding element and the actuator element.

The actuator element may, for example, be a sleeve which is arranged on the coupling base body and/or surrounds a part of the coupling base body.

Retaining elements are moved outwards in order to bear against the inner wall of a pipette tip or against a retaining surface formed on the inner wall of the pipette tip in a coupled state.

In this context, “movement” means a translation and/or tilting of an element, which results in at least one of an axial and radial displacement of the element or at least a part of the element.

The coupling device may comprise at least one of the following components: a stripping sleeve which at least partially surrounds the coupling base body, the retaining elements and the actuator element; a sealing element arranged on the coupling base body; a stop plate for limiting the axial movement of the actuator element; and/or a return element for exerting an axial force on the actuator element.

The term ‘stop plate’ refers to all possible forms of stops that can limit the movement of the actuator element.

The coupling base body may comprise at least one of the following components: a distal end plate; a groove for receiving a sealing element (e.g. O-ring); a cylindrical region; a shaft region; an aspiration and discharge opening extending axially through the coupling base body; and/or a projection for engaging a return element.

The positive guide may comprise at least: a first guide element arranged on the retaining element or elements; and at least one second guide element arranged on the actuator element, which interacts with the first guide element in the form of a positive guide.

The guide elements may each have a guide projection, a guide groove, a guide slide, a slotted link guide, or the like.

In particular, an axial movement of the actuator element positively guides a radial movement (linear translation and/or tilting with a component moving radially) of the retaining element(s). It is not necessary to use a return element in the form of an elastic element, e.g. a spring, rubber or similar, when the retaining elements are extended or retracted. This reduces the number of components required and thus the susceptibility of the system to faults. In addition, it has been shown that the movement of the retaining elements Inwards and outwards) by means of a positive guide may be performed more accurately.

### BRIEF DESCRIPTION OF THE DRAWINGS

The invention is illustrated by the drawings and the following description of the figures.

FIG. 1 shows a perspective view of a coupling device according to the invention in a first state;

FIG. 2a shows a perspective view of a coupling base body according to the invention;

FIG. 2b shows a perspective view of retaining elements according to the invention;

FIG. 3 shows a side view and a top view of the coupling device according to the embodiment of FIG. 1;

FIG. 4 shows a side view and a sectional view of the coupling device according to the embodiment of FIG. 1;

FIG. 5 shows an axial or radial sectional view of the coupling device according to the embodiment of FIG. 1;

FIG. 6 shows a side view of the coupling device according to the embodiment of FIG. 1 in a second state;

FIG. 7 shows an axial sectional view of the coupling device according to the embodiment of FIG. 6;

FIG. 8 shows an enlarged detail of the positive guide of the retaining elements relative to the sleeve according to the invention.

### DESCRIPTION OF A PREFERRED EMBODIMENT OF THE INVENTION

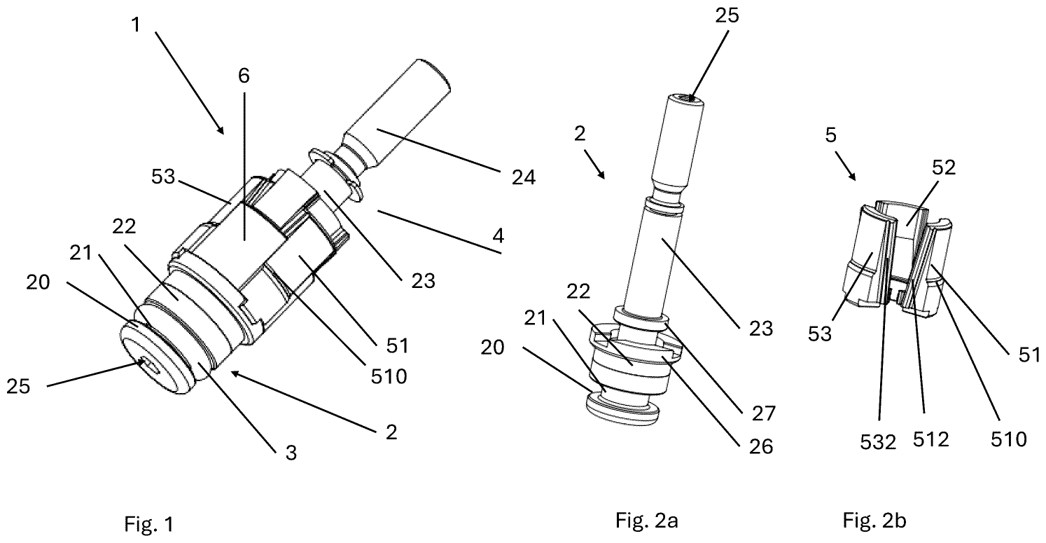

A coupling equipment of a liquid handling system has an ejector sleeve (not shown) and a coupling device according to the invention. FIG. 1 shows a coupling device 1 according to the invention, which has the form of a mandrel that may be partially inserted into the interior of a pipette tip (not shown).

The coupling device 1 has a coupling base body 2. The coupling base body 2 has a distal end plate 20, a groove 21 for a sealing means 3 (e.g. O-ring), a cylindrical region 23 and a shaft region 24. A stop plate 4 may be arranged on the shaft region 24. The coupling base body 2 also has an aspiration and discharge opening 25 extending axially through the entire coupling base body 2 for aspirating or discharging fluids from or to a pipette tip (not shown) coupled to the coupling device 1.

FIGS. 2a and 2b show components of the coupling device 1. FIG. 2a shows the coupling base body 2, while FIG. 2b shows a group of three (3) retaining elements 51, 52, 53. Each of the retaining elements 51, 52, 53 has a step 510 (shown only in the first retaining element 51 as an example).

Furthermore, the coupling device 1 has an actuator sleeve 6, the function of which will be described in more detail below. The retaining elements 51-53 and the actuator sleeve 6 are arranged on a plate-like carrier 26 of the coupling base body 2, wherein the sleeve 6 is axially movable and the retaining elements 51-53 are radially movable and/or tiltable. The movement of the sleeve 6 and the retaining elements 51-53 is coupled, i.e. when the sleeve 6 moves axially upwards (towards the proximal end) or downwards (towards the distal end), the retaining elements 51-53 move inwards and outwards, respectively. The movements are coupled in the form of a positive guide. This means that no elastic element (spring or compressible element) is required for the retaining elements 51-53 to enable or support outward movement and/or inward return movement.

The positive guide may be achieved, for example, by means of corresponding guide elements which are formed in the sleeve 6 and in the retaining elements 51-53 and which interact in accordance with a positive guide, e.g. corresponding guide projections and grooves/slots. In the present example, the retaining elements 51-53 have lateral guide projections (e.g. 512, 532).

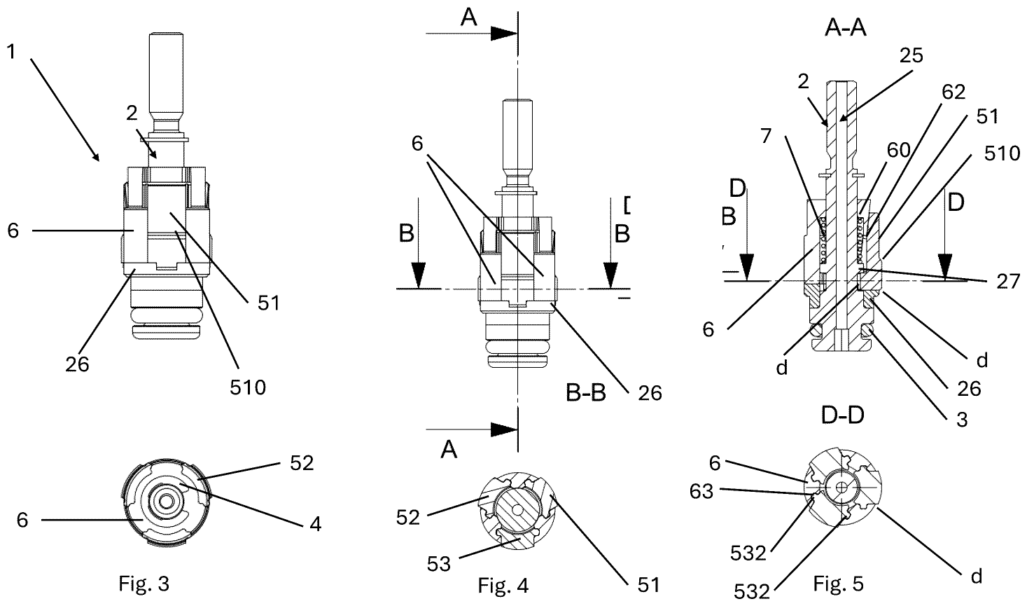

FIGS. 3-5 show side views and cross-sections of the same coupling device 1 in a first state with the retaining elements 51-53 extended, i.e. the state of coupling with a pipette tip. The sleeve 6 is in a first axial position. The retaining elements 51-53 are in a first radial position (which includes a first tilted position). There is a relatively small projection d (corresponding to the inner gap d) beyond the edge of the carrier 26. A compression spring 7 arranged between a projection 27 of the coupling base body 2 and an inner projection 60 of the sleeve 6 is in a compressed state.

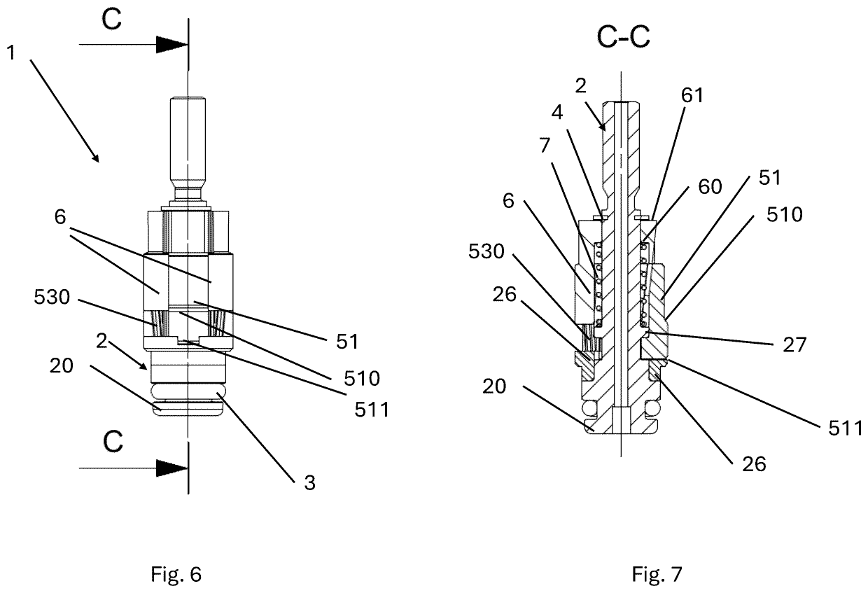

FIGS. 6 and 7 show a side view and a sectional view of the same coupling device 1 in a second state with retracted retaining elements 51-53, i.e. the state of decoupling with a pipette tip. The sleeve 6 is in a second axial position. The retaining elements 51-53 are in a second radial position (which includes a second tilted position). There is no projection beyond the edge of the carrier 26; rather, the lower edges (e.g. 511) of the retaining elements 51-53 are flush with the edge of the carrier 26. A compression spring 7 between the projection 27 of the coupling base body 2 and the inner projection 60 of the sleeve 6 is in a decompressed state. The upper side 61 of the sleeve 6 contacts the stop plate 4, which limits the movement of the sleeve 6 towards the proximal end.

A positive guide 530, e.g. a slide guide or a slotted link guide, ensures that the retaining elements 51-52 perform a radial movement (or tilting movement) corresponding to the axial movement of the sleeve as the sleeve 6 moves axially.

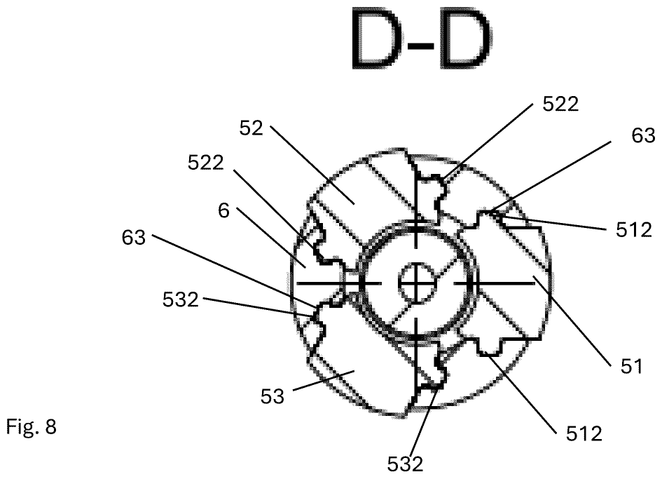

FIG. 8 is an enlarged view of the radial section of FIG. 5 to illustrate the positive guide of the retaining elements 51-53 by means of the projections 512, 522, 532, which engage in a groove (sliding guide) 63 of the actuator sleeve 6. Depending on the radial position of the groove 63, which depends on the axial position of the sleeve 6, the radial position (or tilted position) of the retaining elements 51-53 changes.

1. A coupling device comprising:
a coupling base body;
at least one retaining element which is radially movable relative to the coupling base body;
at least one actuator element which is axially movable relative to the coupling base body; and
a positive guide between the retaining element and the actuator element.

2. The coupling device according to claim 1, comprising at least one of the following components:
a stripping sleeve which at least partially surrounds the coupling base body, the retaining elements and the actuator element;
a sealing element arranged on the coupling base body;
a stop plate for limiting the axial movement of the actuator element; and/or
a return element for exerting an axial force on the actuator element.

3. The coupling device according to claim 1, wherein the coupling base body comprises at least one of the following components:
a distal end plate;
a groove for receiving a sealing element, e.g. O-ring,
a cylindrical region;
a shaft region;
an aspiration and discharge opening extending axially through the coupling base body; and
a projection for engaging a return element.

4. The coupling device according to claim 1, wherein the positive guidance comprises:
at least one first guide element arranged on the retaining element or elements; and
at least one second guide element arranged on the actuator element, which cooperates with the first guide element in the form of a positive guide.

5. The coupling device according to claim 4, wherein the guide elements each have at least one of a guide projection, a guide groove, a guide slide, a slotted link guide, or the like.

6. The coupling device according to claim 1, wherein an axial movement of the actuator element forcibly generates a radial movement (linear translation and/or tilting with a radial component) of the holding element(s).
